(19) United States
(12) Patent Application Publication
(10) Pub. No.: US 2008/0084395 A1
(43) Pub. Date: Apr. 10, 2008

(54) MOTION BASED ADJUSTMENT OF DISPLAY TRANSPARENCY

(76) Inventors: Christopher James Dawson, Arlington, VA (US); Barry Michael Graham, Silver Spring, MD (US); Rick Allen Hamilton, Charlottesville, VA (US); James Wesley Seaman, Falls Church, VA (US)

Correspondence Address: IBM CORP (YA);C/O YEE & ASSOCIATES PC, P.O. BOX 802333, DALLAS, TX, 75380, US

(21) Appl. No.: 11/538,876

(22) Filed: Oct. 5, 2006

(51) Int. Cl. G09G 5/00

(52) U.S. Cl. 345/168

(57) ABSTRACT

A data processing system and a computer implemented method is provided for adjusting the transparency of a display screen based on detecting motion in an area obscured by the display screen. When a motion is detected in the area obscured by the display screen, the transparency of the display screen is adjusted so that the motion is visible through the display screen simultaneously with any data being displayed on the display screen. The transparency may be adjusted depending on the location of the motion, pattern of the motion or both. Patterns of motions may be pre-defined to correspond with specific actions relating to the transparency of the display screen. Furthermore, depending on the location or pattern of the motion, one or more areas of the screen may be adjusted for transparency.

### CROSS REFERENCE TO RELATED APPLICATIONS

The present application is related to application entitled “Display System For Use With Portable Display Device”, Ser. No. 11/461,488, attorney docket no. AUS920060479US1, which is assigned to the same assignee and is incorporated herein by reference.

### BACKGROUND OF THE INVENTION

1. Field of the Invention

The illustrative embodiment relates generally to an improved data processing system, and in particular, to a computer implemented method and apparatus for controlling the characteristics of a display device. Still more particularly, the illustrative embodiment is related to a computer implemented method and apparatus for motion based adjustment of transparency of a display.

2. Description of the Related Art

Computers screens, electronic signboards, and projection surfaces are examples of the commonly used display screens for displaying data. Some display screens employ transparent surfaces and electronic components to make the transparent surface suitable for displaying data. A display with transparent surface can have its transparency adjusted such that the display can go from being completely opaque while displaying data, to being somewhat transparent while displaying data.

Displays include control mechanisms that allow a user to adjust the various characteristics of the display. Adjustment of the transparency of a display is presently controlled by such controls provided with the display. A computer screen, for example, includes buttons to adjust brightness, contrast, shape, and size of the area of display. A display employing a transparent surface may similarly include a button to adjust the transparency of the display.

Presently, displays employing transparent surfaces use a variety of transparent screen technologies. The current technologies use organic light emitting diodes (OLED) in conjunction with thin film transistors (TFT) for making flat panel transparent display surfaces. Such displays are incorporated into a variety of devices and applications to display data.

### SUMMARY OF THE INVENTION

The illustrative embodiments provide a data processing system and a computer implemented method for motion based adjustment of display transparency. The data processing system includes an enclosure for containing the various components of the data processing system, including a keyboard; and a display for displaying data. At least one hinge couples the display to the enclosure such that the display can be lifted up above the keyboard creating space between the display and the keyboard through which a user can manipulate keys on the keyboard. The data processing system also includes a sensor for detecting a motion in an area obscured by the display. When a motion is detected, an included transparency adjuster adjusts the transparency of the display such that the motion is visible through the display simultaneously with the displayed data.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which illustrative embodiments may be implemented;

FIG. 2 is a block diagram of a data processing system in which illustrative embodiments may be implemented;

FIG. 3 is a doubly hinged laptop in accordance with an illustrative embodiment;

FIG. 4 is a component diagram of a doubly hinged laptop in accordance with an illustrative embodiment; and

FIG. 5 is a flowchart of a process for adjusting the transparency of a transparent display in accordance with an illustrative embodiment.

### DETAILED DESCRIPTION OF THE PREFERRED EMBODIMENT

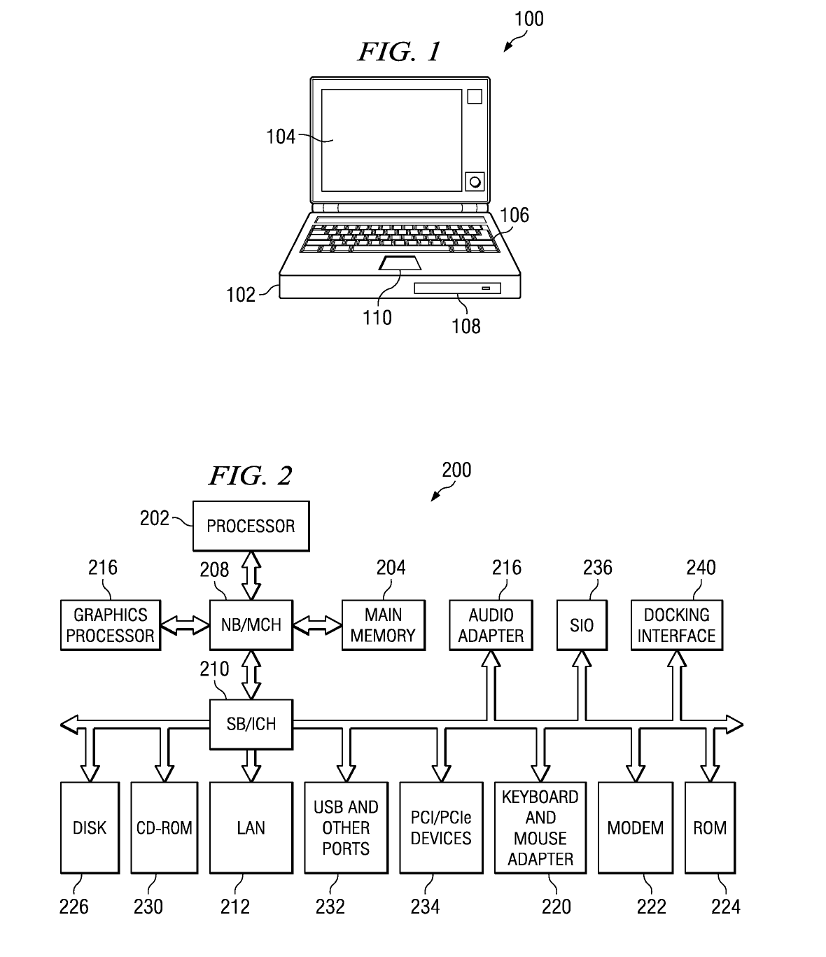

With reference now to the figures and in particular with reference to FIG. 1, a pictorial representation of a data processing system in which illustrative embodiments may be implemented is depicted. Mobile computer 100 is depicted which includes system unit 102, video display terminal 104, keyboard 106, storage devices 108, which may include floppy drives and other types of permanent and removable storage media, and pointer device 110. Additional input devices may be included with mobile computer 100, such as, for example, a mouse, joystick, touch screen, trackball, microphone, and the like. Mobile computer 100 may be implemented using any suitable computer, such as an IBM Thinkpad computer, which is a product of International Business Machines Corporation, located in Armonk, N.Y. Computer 100 also preferably includes a graphical user interface (GUI) that may be implemented by means of systems software residing in computer readable media in operation within computer 100.

With reference now to FIG. 2, a block diagram of a data processing system is shown in which illustrative embodiments may be implemented. Data processing system 200 is an example of a mobile computer, such as computer 100 in FIG. 1, in which code or instructions implementing the processes for different embodiments may be located. In the depicted example, data processing system 200 employs a hub architecture including a north bridge and memory controller hub (MCH) 208 and a south bridge and input/output (I/O) controller hub (ICH) 210. Processor 202, main memory 204, and graphics processor 218 are connected to MCH 208. Graphics processor 218 may be connected to the MCH through an accelerated graphics port (AGP), for example.

In the depicted example, local area network (LAN) adapter 212, audio adapter 216, keyboard and mouse adapter 220, modem 222, read only memory (ROM) 224, hard disk drive (HDD) 226, CD-ROM driver 230, universal serial bus (USB) ports and other communications ports 232, and PCI/PCIe devices 234 may be connected to ICH 210. PCI/PCIe devices may include, for example, Ethernet adapters, add-in cards, PC cards for notebook computers, etc. PCI uses a cardbus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be connected to ICH 210.

Docking interface 240 may also be connected to the ICH. Data processing system 200 may be a mobile computing device, such as a laptop computer or handheld computer. Docking interface 240 provides port replication to allow the data processing system to easily connect to a keyboard, pointing device, monitor, printer, speakers, etc. The docking interface allows the mobile computing device to operate as a desktop computer with the more immobile peripheral devices.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202. The processes of the illustrative embodiments are performed by processor 202 using computer implemented instructions, which may be located in a memory such as, for example, main memory 204, memory 224, or in one or more peripheral devices 226 and 230.

Those of ordinary skill in the art will appreciate that the hardware in FIG. 2 may vary depending on the implementation. Other internal hardware or peripheral devices, such as flash memory, equivalent nonvolatile memory, or optical disk drives and the like, may be used in addition to or in place of the hardware depicted in FIG. 2. Also, the processes of the depicted embodiments may be applied to a multiprocessor data processing system.

For example, data processing system 200 may be a personal digital assistant (PDA), which is configured with flash memory to provide non-volatile memory for storing operating system files and/or user-generated data. The depicted example in FIG. 2 and above-described examples are not meant to imply architectural limitations. For example, data processing system 200 also may be a tablet computer or telephone device in addition to taking the form of a PDA.

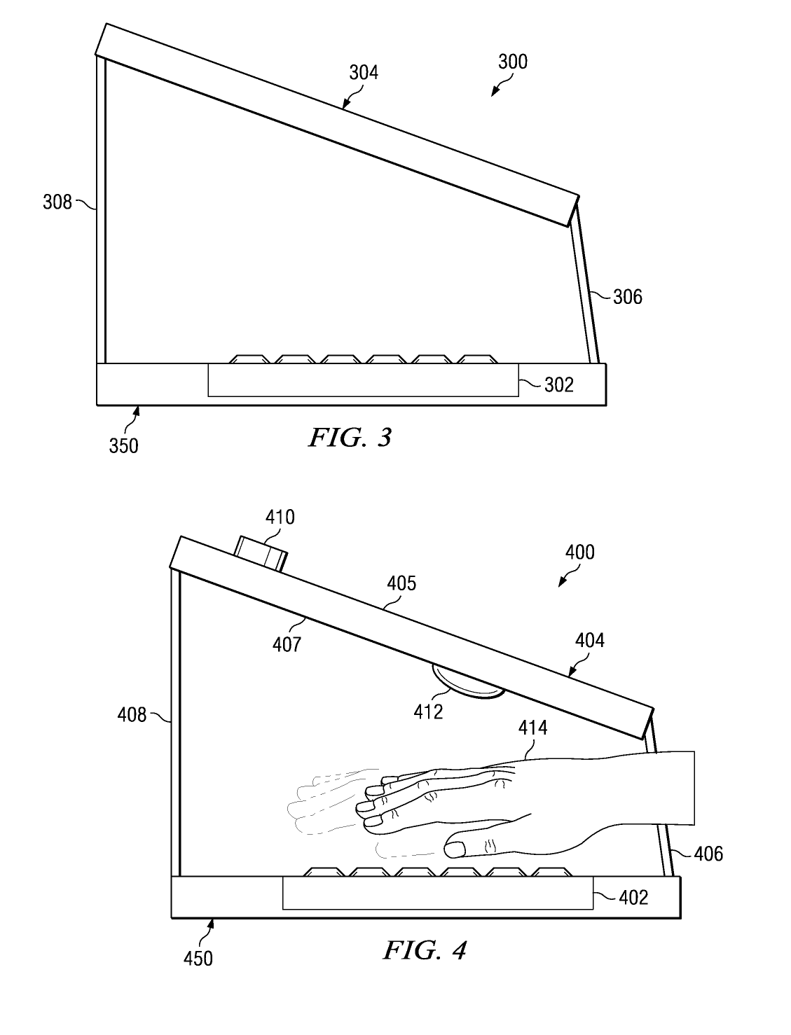

With reference now to FIG. 3, a doubly hinged laptop 300 is shown in accordance with an illustrative embodiment. Doubly hinged laptop 300 comprises a keyboard 302 and a display 304. Display 304 is a commonly used opaque display such as those used in currently available single hinge laptop computers. The keyboard and several other components of the laptop are generally contained in an enclosure, such as enclosure 350. Display 304 is coupled to enclosure 350 using two hinges, front hinge 306 and back hinge 308. When laptop 300 is opened as shown, hinges 306 and 308 lift display 304 up above keyboard 302 as opposed to flipping the display up perpendicular to the keyboard. Double hinges are shown here only as an example of a hinge system that permits the described orientation of the display with respect to the enclosure. A hinge system may include one or more hinges as described, or other coupling mechanisms, such as a coaxial plunger type connector that operates with pneumatic power, to perform the described orientation of the display.

Solid surfaces can visually block things that are behind those surfaces. As in the case of doubly hinged laptop 300 in FIG. 3, by lifting up above the keyboard, the display would overlay and obscure the keyboard. Positioning of the display and the keyboard, relative to each other in this manner, will make it difficult for the user to see the finger placement over the keys of the keyboard.

Displays employing transparent surfaces for displaying data can allow some degree of transparency through them so that a user can see the things behind them. Such displays are called transparent displays. However, the illustrative embodiments recognize that increasing the transparency of a transparent display is not always desirable. For example, increased transparency can lead to reduced readability of the data being displayed. Therefore, a mechanism that allows the adjustment of the transparency of a transparent display on an as-needed basis would be useful. This way, the transparent display could remain at high opacity allowing good readability for most of the time, and become partially transparent only when needed.

The illustrative embodiments also recognize that at present, transparent displays are monolithic in adjusting the transparency. When transparency is adjusted, the adjustment applies to the entire display area. Therefore, a mechanism that allows the selective adjustment of transparency of only a selected area would be useful. Furthermore, several selected areas forming a set of areas could be selectively adjusted for transparency. The illustrative embodiments recognize that in this manner, at least some of the data being displayed in the areas not affected by the increased transparency will retain their greater readability.

With reference now to FIG. 4, a component diagram of a doubly hinged laptop is depicted in accordance with an illustrative embodiment. FIG. 4 describes an exemplary implementation of the illustrative embodiments in the form of a doubly hinged laptop, such as doubly hinged laptop 300 in FIG. 3. The doubly hinged laptop is used to describe the illustrative embodiments only for the clarity of the description and is not intended to be limiting on the illustrative embodiments.

Doubly hinged laptop 400 comprises a keyboard 402 and a display 404. The keyboard and several other components of the laptop are generally contained in an enclosure, such as enclosure 450. Display 404 is a transparent display as described above, and is coupled to enclosure 450 using two hinges, front hinge 406 and back hinge 408. When laptop 400 is opened as shown, hinges 406 and 408 lift display 404 up above keyboard 402.

Display 404 includes transparency control switch 410 that can be used to manually adjust the transparency of the display. Display 404 displays data on the surface 405, which is marked “top” in the illustration of FIG. 4. The back side of surface 405 is the surface 407, which is marked “bottom” and faces the keyboard. Normally, when display 404 is displaying data on the top surface 405 with full opacity, any movement between the bottom surface of the display and the keyboard will be obscured.

Display 404 further includes motion sensor 412 on the bottom surface 407. Motion sensor 412 is capable of detecting motion between the bottom surface of display 404 and keyboard 402, such as motion of a user's hand 414 over the keyboard. Motion sensor 412 is coupled to laptop 400 is such a way that signals resulting from sensing any motion in the space between display 404 and keyboard 402 is transmitted to laptop 400. A processor, such as processor 202 in FIG. 2, and other components as shown in FIG. 2 reside within laptop 400. A combination of software instructions and one or more of hardware components shown in FIG. 2 act as a transparency adjuster and use these signals to adjust the transparency of a set of areas of display 404 by a pre-determined amount. A transparency adjuster is a circuitry, or a circuitry controlled by software, that adjusts the transparency characteristic of the display. For example, software located in the main memory, such as main memory 204 in FIG. 2, may react to the detection of the user's hands and send a signal to the graphics processor, such as graphics processor 218 in FIG. 2, to increase the transparency parameter of the display.

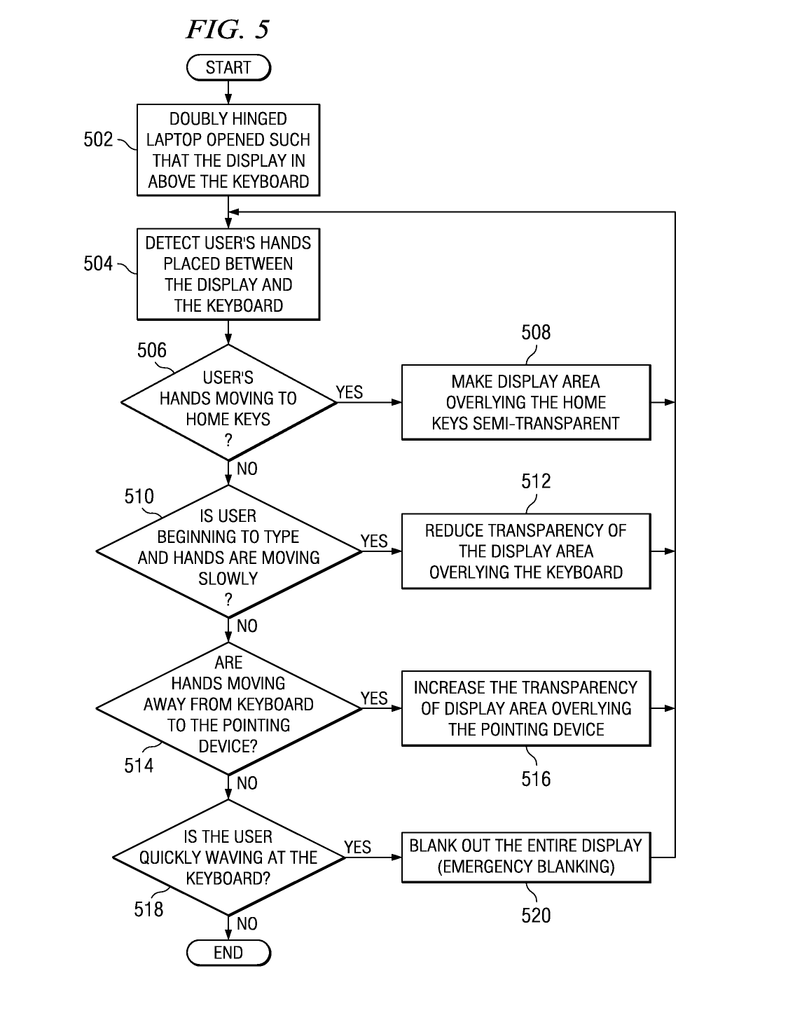

With reference now to FIG. 5, a flowchart of a process for adjusting the transparency of a transparent display is depicted in accordance with an illustrative embodiment. FIG. 5 continues to describe the illustrative embodiment using the doubly hinged laptop shown in FIG. 4. The process in FIG. 5 can be implemented in a data processing system with a transparent display, such as doubly hinged laptop 400 in FIG. 4.

The process begins when a doubly hinged laptop, such as doubly hinged laptop 400 in FIG. 4, is opened such that its display, such as display 404 in FIG. 4, is over its keyboard, such as keyboard 402 in FIG. 4 (step 502). Next, the process detects whether a user's hands are placed between the display and the keyboard of the opened laptop such that the hands are obscured by the display (step 504).

Upon detecting user's hands being present between the display and the keyboard in step 504, the process then determines whether the motions of the user's hands match any pattern of motions and takes corresponding pre-defined actions with respect to the transparency of the display. A pattern of motion is a sequence of one or more motions of pre-determined angle, form, length, duration, and position characteristics, or a combination of these characteristics.

The process determines whether the user's hands are moving to the “home” keys on the keyboard (step 506). This pattern of motion is pre-defined and if the motion of the user's hands matches this pattern (“yes” path of step 506), the process takes the corresponding action by making the areas of the display overlying the home keys semi-transparent (step 508). This adjustment of transparency helps the user in locating the home keys, otherwise obscured by the display. If, however, the pattern of step 506 does not match with the pattern of user's hand motion (“no” path of step 506), the process proceeds to the next pattern.

Display transparency may be understood in terms of degrees of transparency. For example, a display may be fully opaque, partially transparent, semi-transparent, or fully transparent. Alternatively, a display may also be said to be zero percent transparent, seventeen percent transparent, fifty percent transparent, or one hundred percent transparent.

Next, the process determines whether the user is starting to type and the hands are moving slowly over the keys of the keyboard (step 510). If the motion of the user's hands matches this pattern (“yes” path of step 510), the process adjusts the transparency of the display such that the area of the display overlying the keyboard is made visible through reduced transparency (step 512). Reduced transparency is a degree of partial transparency. If, however, the pattern of step 510 does not match with the pattern of user's hand motion (“no” path of step 510), the process proceeds to the next pattern.

The process then determines whether the hands are moving away from the keyboard towards the pointing device integrated on the keyboard (step 514). If the motion of the user's hands matches this pattern (“yes” path of step 514), the process responds by increasing the transparency of the display area overlying the pointing device (step 516). If, however, the pattern of step 514 does not match with the pattern of user's hand motion (“no” path of step 514), the process proceeds to the next pattern.

Specific hand motions may be programmed into the process such that upon detecting those motions, the process takes specific actions with respect to the transparency of the display. For example, the process determines whether the hands are moving laterally quickly, as if waving at the keyboard (step 518). If the motion of the user's hands matches this pattern (“yes” path of step 518), the process makes the entire display blank in response to the specific motion (step 520). The process returns to step 504 to await new motion patterns and take corresponding actions. If, however, the pattern of step 518 does not match with the pattern of user's hand motion (“no” path of step 518), the process terminates thereafter.

Any number of motions and corresponding actions for adjusting screen transparency may be programmed into the process depicted in FIG. 5. Furthermore, the process may take several actions, over several areas of the display, upon detecting a certain motion. Similarly, any number of specific motions may be programmed for the process to take any number of specific actions with respect to the transparency of the display. The motions and actions described in FIG. 4 are only exemplary, and not intended to be limiting on the illustrative embodiments.

Another exemplary application of the illustrative embodiments could be in medical devices. A surgeon could be operating on a patient with a transparent display between the surgeon and the patient, displaying images overlaying the patient, or displaying other information useful for the surgical procedure. As the surgeon's hands and instruments move on the patient instead of a keyboard, the transparent display employing the illustrative embodiments could adjust the transparency of certain areas so that the surgeon can see both, the surgeon's hands and the data displayed on the transparent display.

Thus, the illustrative embodiments provide a method and an apparatus that allow a user of a transparent display to see the displayed data as well as things moving behind the transparent display. In the manner described above, the problem of solid surfaces visually obscuring things situated behind them is solved.

The double hinged laptop and the medical device application are described here only as exemplary applications of the illustrative embodiments. These examples are not intended to be limiting on the illustrative embodiments. Many more applications will become apparent to a person of ordinary skill in the pertinent art upon reading this disclosure.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the illustrative embodiment has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A data processing system for motion based adjustment of display transparency, the data processing system comprising:
an enclosure containing a processor and a memory;
a display, wherein data is present on the display forming displayed data;
a keyboard located on the enclosure, wherein data is entered using the keyboard;
a hinge system connected to the display and the enclosure, wherein the hinge system allows the display to lift up above the keyboard creating space between the display and the keyboard and wherein the user may place members in the space to use the keyboard; a sensor located on at least one of the display and the enclosure, wherein the sensor detects a motion in an area obscured by the display; and
a transparency adjuster, wherein the transparency adjuster adjusts a transparency of the display such that the motion is visible through the display simultaneously with the displayed data in response to detecting the motion.

2. The data processing system of claim 1, wherein a plurality of patterns of the motion determines a level of transparency of the display.

3. The data processing system of claim 1, wherein a plurality of patterns of the motion determines a set of areas of the display where the transparency of the display is adjusted.

4. The data processing system of claim 1, wherein a location of the motion determines an area of the display where the transparency of the display is adjusted.

5. A computer implemented method for motion based adjustment of transparency of a display, the computer implemented method comprising:
displaying data on the display to form displayed data;
monitoring for a motion in an area obscured by the display; and
responsive to detecting the motion, adjusting the transparency of the display such that the motion is visible through the display simultaneously with the displayed data.

6. The computer implemented method of claim 5, wherein a plurality of patterns of the motion determines the level of transparency of the display.

7. The computer implemented method of claim 5, wherein a plurality of patterns of the motion determines a set of areas of the display where the transparency of the display is adjusted.
